(19) United States
(12) Patent Application Publication
(10) Pub. No.: US 2024/0411033 A1
(43) Pub. Date: Dec. 12, 2024

(54) AUTOMATIC DRIVING POSITIONING METHOD AND SYSTEM, TESTING METHOD, DEVICE, AND STORAGE MEDIUM

(71) Applicant: BEIJING NATIONAL NEW ENERGY VEHICLE TECHNOLOGY INNOVATION CENTER CO. , LTD., Beijing (CN)

(72) Inventors: Ting ZHANG, Beijing (CN); Dinghai PAN, Beijing (CN); Chengyin YUAN, Beijing (CN)

(21) Appl. No.: 18/701,031

(22) PCT Filed: Aug. 11, 2022
(86) PCT No.: PCT/CN2022/111845

§ 371 Date: Apr. 12, 2024

(30) Foreign Application Priority Data
Nov. 19, 2021 (CN) 202111374084.1

(51) Int. Cl. G01S 19/48; G01S 17/89; G06T 7/73

(52) U.S. Cl. CPC G01S 19/485; G01S 17/89; G06T 7/73; G06T 2207/10028; G06T 2207/30241; G06T 2207/30252

(57) ABSTRACT

An automatic driving positioning method and system, a testing method, a device, and a storage medium, which relate to the technical field of automatic driving positioning. Said method employs fusion data generated after positioning data outputted by an integrated navigation and laser SLAM is processed by means of extended Kalman filtering, verifies input data by reversing positioning results of fusing real-time laser positioning and integrated navigation, that is, the fusion data is used to eliminate abnormal data in integrated navigation and laser SLAM positioning to form a real-time closed-loop positioning system, and then the automatic driving positioning system is tested by means of a test method, so as to provide a novel test and verification solution for the automatic driving positioning system. Said method may effectively increase positioning accuracy and improve the reliability of integrated navigation.

### FIELD OF TECHNOLOGY

The present disclosure belongs to the technical field of automatic driving positioning, and particularly relates to a positioning method and system for automatic driving, testing method, device and storage medium.

### BACKGROUND

Vehicle automatic driving is a cutting-edge research technology in recent years, which requires complete, safe and efficient driving of cars without human manipulation. Positioning is a basic module of automatic driving. A key prerequisite for continuously safe and reliable operation of the automatic driving system is that the positioning system of the vehicle must output sufficiently high-precision position and position-related information in real time and stably, including longitude, latitude, velocity, pitch angle, heading angle, update frequency and etc. of the vehicle. Once the information cannot be obtained in a timely and accurate manner, the vehicle will not be able to determine its own position, and must immediately exit the automatic driving mode, and the driver will take over the control of the vehicle.

In order to realize an automatic driving system of a vehicle, high-precision positioning and navigation technology must be adopted. GNSS and IMU integrated navigation system is a commonly used positioning solution in the automatic driving system. GNSS (Global Navigation Satellite System) can provide accurate absolute positioning, but in local areas where the satellite signal is lost or weak, the positioning information will be delayed and the vehicle will be out of control. Although IMU (inertial navigation) can provide stable position and velocity information without relying on external information and fearing of extreme environments, there is a problem that positioning errors accumulate over time and sufficient navigation accuracy cannot be guaranteed for a long time. The integrated navigation system formed by the fusion of GNSS and IMU can take advantage of the advantages of the two navigation systems. However, in complex scenarios, affected by signal occlusion and multipath effects, the current GNSS/IMU integrated navigation system still cannot achieve long-term and long-distance stable positioning.

Therefore, in view of the existing technology, because accurate and real-time positioning cannot be realized in all areas, and there is still a lot of room for improvement in various aspects such as positioning accuracy and system robustness, the purpose of the present disclosure is to address the lack of a systematic testing method for automatic driving positioning, which leads to low reliability and low positioning accuracy of integrated navigation, and proposes a positioning method and system for automatic driving, a testing method, a device and storage medium.

### SUMMARY

In order to solve the deficiencies in the prior art, the present disclosure provides a positioning method and system for automatic driving, testing method, device and storage medium.

The technical content of the present disclosure is as follows:

A positioning method for automatic driving, comprising:
inputting data sets of position, velocity and attitude angle, and real-time laser point cloud data;
processing the acquired data sets of position, velocity and attitude angle by using extended Kalman filter method;
processing the acquired real-time laser point cloud data by using a laser SLAM algorithm and then using the extended Kalman filter method;
acquiring fusion output positioning data after the processing with the extended Kalman filter method, and eliminating input abnormal data by using the fusion output positioning data to form closed-loop processing.

Furthermore, the real-time laser point cloud data is processed by using the laser SLAM algorithm to generate data of position and heading angle.

Furthermore, generating fusion output positioning data of position, velocity and attitude angle after the processing with the extended Kalman filter method, and using the fusion output positioning data to eliminate abnormal data in input data to form closed-loop processing.

Furthermore, eliminating abnormal data comprising the steps of:
step 1: determining starting points of the fusion output positioning data, input position trajectory and laser SLAM position trajectory;
step 2: using linear interpolation method to perform interval resampling on the fusion output positioning data, the input position trajectory and the laser SLAM position trajectory in step 1;
step 3: calculating a distance between resampling points with an equal interval, and extracting and eliminating abnormal position data input by the integrated navigation and the laser SLAM;
step 4: based on the fusion output velocity, extracting and eliminating input abnormal velocity data by using curve similarity analysis method;
step 5: based on the fusion output attitude angle data, extracting and eliminating abnormal angle data input from the integrated navigation and the laser SLAM by using the curve similarity analysis method.

The present disclosure provides a positioning system for automatic driving, comprising: an integrated navigation device module, a laser radar module, an automatic driving controller module and an automatic driving positioning module,
the integrated navigation device module is configured to provide data sets of position, velocity and attitude angle to the automatic driving positioning module;
the laser radar module is configured to provide real-time laser point cloud data to the automatic driving positioning module;
the automatic driving positioning module is configured to implement a positioning method for automatic driving;
the automatic driving controller module is configured to run the automatic driving positioning module.

Furthermore, the automatic driving positioning module adopts an automatic driving positioning program based on integrated navigation and laser SLAM fusion technology.

The present disclosure provides a test method applicable to the positioning system for automatic driving, the test method comprising:
complete the test of the positioning system for automatic driving by combined test of the integrated navigation device module and the automatic driving positioning module.

Furthermore, test steps of the integrated navigation device module comprising:
step 1: testing positioning stability of the integrated navigation device in a static state;
step 2: testing changes of different positioning states of the integrated navigation device in a motion state;
step 3: using a high-precision navigation and positioning system as reference to test positioning accuracy of the integrated navigation device;
step 4: testing switching time between a fixed solution and a non-fixed solution of the integrated navigation device;
step 5: testing change in time of repeated cold starts of the integrated navigation device;
step 6: testing and analyzing packet loss rate and packet loss interval of the integrated navigation device.

Furthermore, test steps of the automatic driving positioning module comprising:
step 1: in a site with excellent GNSS signals and complete fixed facilities, arranging a fixed navigation trajectory to test positioning accuracy and update frequency of positioning data; and
step 2: testing the positioning accuracy and data processing time for automatic driving in a GNSS signal blocked area.

The present disclosure also provides a positioning device for automatic driving, wherein the device comprising: a memory, a processor, and an automatic driving positioning program stored on the memory and running on the processor, the automatic driving positioning program is configured to implement steps of the positioning method for automatic driving.

The present disclosure also provides an electronic storage medium, wherein at least one instruction or at least one section of program is stored in the storage medium, and the at least one instruction or at least one section of program is loaded and executed by a processor to implement the positioning method for automatic driving.

The present disclosure at least has the following beneficial effects:
(1) The present disclosure adopts a real-time closed-loop automatic driving positioning method based on the fusion of integrated navigation and laser SLAM, which can make up for the defect that satellite signals are easily affected by the environment, further improve the reliability of integrated navigation, and effectively improve positioning accuracy;
(2) the positioning method of the automatic driving positioning system of the present disclosure is a closed-loop processing method, the positioning data input by the integrated navigation device and laser SLAM is processed by the extended Kalman filter, and the output result data will be used to screen the input positioning data of the integrated navigation device and laser SLAM, and reversely verify the validity of the input data, and the real-time laser positioning method based on deep learning is used to output laser positioning data with high accuracy and strong robustness, making the fusion positioning data more reliable;
(3) the function-level test method of the automatic driving positioning system provided by the present disclosure is applicable to any automatic driving positioning system including an integrated navigation device; the present disclosure carries out testing for automatic driving positioning system from the two aspects of test of the integrated navigation device and test of positioning function, and a set of test methods for integrated navigation device are set up from six aspects of static positioning data stability, positioning state, positioning accuracy, fixed solution switching time, cold start time, and packet loss, which provides a new validation plan for the test and verification of automatic driving positioning system, and the test is easy to operate and has high reliability of test results.

### BRIEF DESCRIPTION OF THE DRAWINGS

FIG. 1 is a structural schematic diagram of the overall structure process of the present disclosure.

FIG. 2 is a schematic diagram of the flow structure of the positioning system for automatic driving of the present disclosure.

FIG. 3 is a schematic structural diagram of a laser SLAM processing flow in an embodiment of the present disclosure.

FIG. 4 is a schematic diagram of a flow structure of eliminating input abnormal data based on fused positioning data in an embodiment of the present disclosure.

FIG. 5 is a schematic structural diagram of testing of the integrated navigation device of the present disclosure.

### DESCRIPTION OF THE EMBODIMENTS

In order to make the purpose, technical solutions and advantages of the embodiments of the present disclosure clearer, the technical solutions in the embodiments of the present disclosure will be clearly and completely described below in conjunction with the drawings in the embodiments of the present disclosure. Obviously, the described embodiments are a part of embodiments of the present disclosure, but not all embodiments. Based on the embodiments of the present disclosure, all other embodiments obtained by persons of ordinary skill in the art without creative efforts fall within the protection scope of the present disclosure.

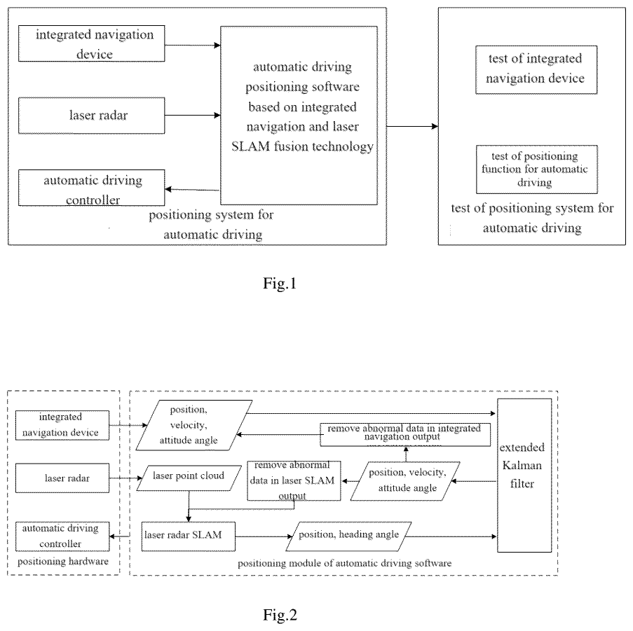

In combination with FIG. 1-FIG. 5, the present disclosure provides a positioning method for automatic driving, comprising:
inputting data sets of position, velocity and attitude angle of an integrated navigation device and real-time laser point cloud data of a laser radar;
wherein the data set of position of the integrated navigation is P1={(x₁₀, y₁₀, z₁₀), . . . , (x₁ᵢ, y₁ᵢ, z₁ᵢ), . . . }, the data set of velocity is V1={(vₓ₁₀,v_{y10},v_{z10}), . . . , (vₓ₁ᵢ,v_{y1i},v_{z1i}), . . . }, and the data set of attitude angle is A1={(α₁₀,β₁₀,γ₁₀), . . . , (α₁ᵢ,β₁ᵢ,γ₁ᵢ), . . . };
processing the acquired data sets of position, velocity and attitude angle of the integrated navigation device by using extended Kalman filter method;
processing the acquired real-time laser point cloud data of the laser radar by using a laser SLAM algorithm and then by using the extended Kalman filter method; processing the real-time laser point cloud data by using the laser SLAM algorithm to generate data of position and heading angle.

The laser point cloud data is processed by using the laser SLAM algorithm to generate the position and heading angle. The laser SLAM algorithm uses the deep learning model to learn the point cloud features, and outputs more accurate and robust positioning results. At the same time, the process of feature matching and pose calculation is combined with point cloud feature maps produced in real time, which reduces the calculation time of laser positioning and has higher real-time performance, making the fusion results of laser positioning and integrated navigation more reliable.

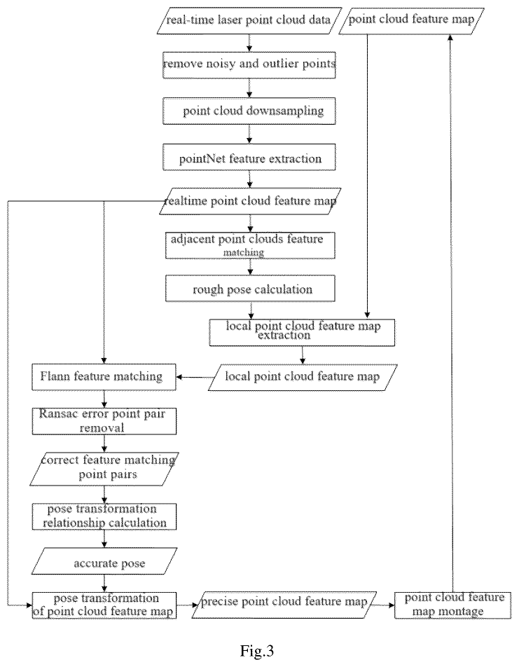

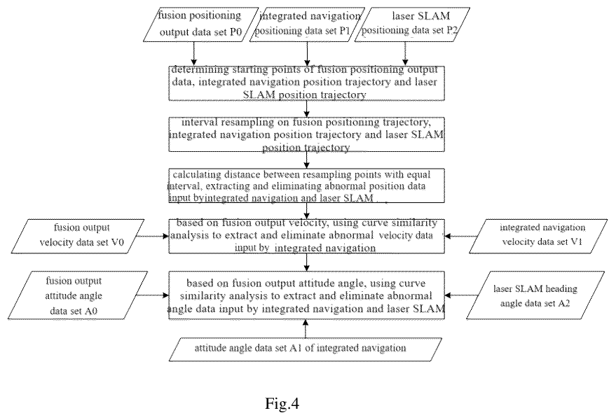

The processing flow of the laser SLAM algorithm is shown in FIG. 3. Real time laser point cloud data is processed by eliminating noisy and outlier points, downsampling point clouds, and extracting PointNet features to generate real-time point cloud feature maps. Adjacent point cloud feature matching is performed, rough pose is calculated, and local point cloud feature maps are extracted based on the rough pose. Then, after Flann feature matching and Ransac error point pair removal processing, the correct feature matching point pairs are obtained. Based on the correct feature matching point pairs, the pose transformation relationship is calculated and the precise pose is output, the precise pose includes set of position P2={(x₂₀, y₂₀, z₂₀), . . . , (x₂ᵢ, y₂ᵢ, z₂ᵢ), . . . }, and set of heading angle A2={γ₂₀, . . . , γ₂ᵢ, . . . }. At the same time, based on the precise pose, the point cloud feature map is transformed to generate the precise point cloud feature map and concatenate the complete point cloud feature map, thus the point cloud feature map is generated. The generated point cloud feature map can be combined in the processing of the real-time laser point cloud data to directly extract local point cloud feature map, reducing the calculation time of laser positioning. When the real-time laser point cloud data is processed by using the laser SLAM algorithm, the generated real-time point cloud feature map can be directly processed for Flann feature matching, Ransac error point pair removal, and the pose of the point cloud feature map can also be directly transformed.

After the processing with the extended Kalman filter method, fusion output positioning data are acquired, and input abnormal data are eliminated by the fusion output positioning data to form closed-loop processing.

Fusion output positioning data of position, velocity and attitude angle are generated after the processing of the extended Kalman filter method, and abnormal data in the integrated navigation and laser SLAM positioning are eliminated using the fusion output positioning data to form closed-loop processing.

Using the extended Kalman filter method, the output data of the integrated navigation device is used as the initial value, and the positioning data output by the integrated navigation and laser SLAM is used as the observation quantity, and the comprehensive output set of position is P0={(x₀₀,y₀₀,z₀₀), . . . , (x₀ᵢ,y₀ᵢ,zₒᵢ), . . . }, set of velocity is V0={(vₓ₀₀, v_{y00}, x_{z00}), . . . , (vₓ₀ᵢ, v_{y0i}, v_{z0i}), . . . }, and set of attitude angle is A0={(α₀₀, β₀₀,γ₀₀), . . . , (α₀ᵢ, β₀ᵢ,γ₀ᵢ), . . . }.

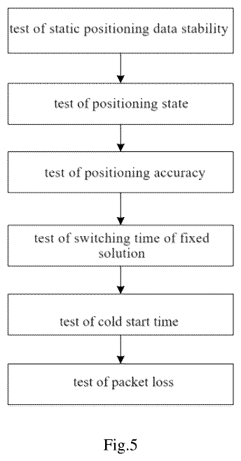

FIG. 4 shows the process of eliminating input abnormal data with fusion positioning results.

Compare the trajectory similarity of P1, P2 and P0, and eliminate the abnormal values in P1 and P2 through the curve similarity analysis method, the steps are as follows:
confirming the starting position P₀₀=(x₀₀, y₀₀, z₀₀) of the fusion positioning output data set P0, based on the integrated navigation positioning data P1 and the laser SLAM data P2, calculating position points P₁₀=(x₁₀, y₁₀, z₁₀) and P₂₀=(x₂₀,y₂₀,z₂₀) with the shortest distance to P₀₀ among the integrated navigation position trajectory and the laser SLAM trajectory, and taking P₁₀ and P₂₀ as starting points of the integrated navigation position trajectory and the laser SLAM trajectory; using linear interpolation method to perform equal interval resampling on P0, P1 and P2, and represent the trajectory sets P0, P1 and P2 with sampling points with interval d, which are represented by P0′, P1′ and P2′, respectively, P0′={P₀₀,P₀₁, . . . , P₀ⱼ, . . . }, P1′={P₁₀,P11, . . . , P₁ⱼ, . . . }, P2′={P₂₀,P₂₁, . . . , P₂ⱼ, . . . }, wherein P₀ⱼ=P₀₀+j*d, P₁ⱼ=P₁₀+j*d, P₂ⱼ=P₂₀+j*d;
calculating distances between each point on P0 and the corresponding points on P1 and P2, which are DT1={dist(P₀₀,P₁₀),dist(P₀₁,P₁₁), . . . , dist(P₀ⱼ,P₁ⱼ), . . . } and DT2={dist(P₀₀,P₂₀), dist(P₀₁,P₂₁), . . . , dist(P₀ⱼ,P₁ⱼ), . . . }. Setting a certain distance threshold T_{D}, recording the points in P1′ and P2′ corresponding to the distance values exceeding T_{D} in DT1 and DT2, and the points near these points in P1 and P2 are the abnormal positioning data input by the integrated navigation and laser SLAM, and eliminating the abnormal data;
based on the velocity data of the fusion output, using the curve similarity analysis method to compare the change trends of V1 and V0 over time, and eliminating the abnormal velocity data in the integrated navigation input velocity V1;
based on the attitude angle data of the fusion output, using the curve similarity analysis method to compare the change trends of A1, A2 and A0 over time, and eliminating the abnormal angle data in the attitude angle A1 input by the integrated navigation and the attitude angle A2 input by the laser SLAM.

The present disclosure provides a positioning system for automatic driving, comprising: an integrated navigation device module, a laser radar module, an automatic driving controller module and an automatic driving positioning module,
the integrated navigation device module is configured to provide data sets of position, velocity and attitude angle to the automatic driving positioning module;
the laser radar module is configured to provide real-time laser point cloud data to the automatic driving positioning module;
the automatic driving positioning module is configured to implement a positioning method for automatic driving;
the automatic driving controller module is configured to run the automatic driving positioning module.

Furthermore, the automatic driving positioning module adopts an automatic driving positioning program based on integrated navigation and laser SLAM fusion technology.

The present disclosure provides a test method applicable to the positioning system for automatic driving, the test method comprising:
complete the test of the positioning system for automatic driving by combined test of the integrated navigation device module and the automatic driving positioning module.

The test of the integrated navigation device module comprises:

1. Test of static positioning data stability: testing positioning stability of the integrated navigation device in a static state, and counting the distribution of position data over a period of time in a static state.

Install the integrated navigation device on the vehicle, park the vehicle statically in an open area, wait for the integrated navigation device to receive stable satellite signals, and record the received data in a period of time ΔT after the device is in a stable state, calculate the distribution of position data x and y, calculate the range, variance, standard deviation, and covariance of x and y, and analyze the dispersion of the position data through the following formula.

Range of x, y: Rₓ=xₘₐₓ−xₘᵢₙ, R_{y}=yₘₐₓ−yₘᵢₙ, wherein xₘₐₓ, xₘᵢₙ, yₘₐₓ, yₘᵢₙ are the maximum value of x, the minimum value of x, the maximum value of y, and the minimum value of y, respectively.

Variance and standard deviation of x:

$${σ}^{2} = \frac{{\sum }_{i = 1}^{n} {( {x}_{i} - \overline{x} )}^{2}}{n} ,$$

$$σ = \sqrt{\frac{{\sum }_{i = 1}^{n} {( {x}_{i} - \overline{x} )}^{2}}{n}} ;$$

$${σ}^{2} = \frac{{\sum }_{i = 1}^{n} {( {y}_{i} - \overline{y} )}^{2}}{n} ,$$

$$σ = \sqrt{\frac{{\sum }_{i = 1}^{n} {( {y}_{i} - \overline{y} )}^{2}}{n}} ;$$

Variance and standard deviation of y:
wherein x̅ is the average value of x, y̅ is the average value of y, and n is the number of data records.

Covariance of x and y:

$$cov ( x , y ) = \frac{{\sum }_{i = 1}^{n} ( {x}_{i} - \overline{x} ) ( {y}_{i} - \overline{y} )}{n - 1} .$$

2. Test of positioning state: testing changes of different positioning states of the integrated navigation device in a motion state.

Select the testing site and operating trajectory, and drive the same vehicle installed with the integrated navigation along the specified trajectory at different speeds. The device receives data, calculates the operating trajectory under different positioning states such as fixed solution, floating point solution, pseudorange solution, and single point solution, calculates the proportion of trajectories under different positioning states at different speeds, and analyzes the positioning stability of the integrated navigation device in a motion state.

3. Test of positioning accuracy: using a high-precision navigation and positioning system as reference, comparing and analyzing the position error of the integrated navigation device and the reference positioning system on the same trajectory, and testing positioning accuracy of the integrated navigation device.

Arrange a fixed navigation trajectory in an open testing site, make the vehicle installed with the integrated navigation device to be tested to drive along the navigation trajectory, record the received positioning data set {x, y}; dismantle the integrated navigation device to be tested, install a high-precision navigation and positioning system at the same position on the same vehicle, record the received reference positioning data set {x0, y0} in the same way, and form the reference trajectory curve R0. Calculate the distance from each positioning point in {x, y} to R0, forming a set {d}, which is the positioning error. Set the range of error statistical intervals, calculate the number of points falling into each interval, and count the distribution of d. Calculate the maximum value dₘₐₓ, minimum value dₘᵢₙ, and average value d in {d}.

4. Test of switching time of fixed solution: testing switching time between a fixed solution and a non-fixed solution of the integrated navigation device.

Drive the vehicle installed with the integrated navigation device to be tested along the specified trajectory at different speeds, record the received data content, record the time points from fixed solution to non-fixed solution, and from non-fixed solution to fixed solution, and calculate the time difference.

5. Test of cold start time: testing change in time of repeated cold starts of the integrated navigation device.

Select a site with a good positioning signal for the integrated navigation device to be tested, turn off the power of the device by unplugging the power, wait for a period of time (for example, 5 minutes), power on the device and receive data, and record the time T from power on to the first observation with a fixed solution. Power off the device, repeat the same operation several times, record the time T, and calculate the maximum value, minimum value, average value and standard deviation of T.

6. Test of packet loss: testing and analyzing packet loss rate and packet loss interval of the integrated navigation device, including data comparison test and data integrity test.

Data comparison test: Make the vehicle installed with the integrated navigation device to be tested to drive along the specified trajectory at different speeds, record the data content sent by the device through the communication interface, compare the data content received and recorded internally the device, analyze and calculate the packet loss rate at different speeds, and check the interval of packet loss in the driving trajectory.

Data integrity test: According to the data content sent by the integrated navigation device through the communication interface, count the time continuity, check the integrity of the data itself, calculate the packet loss rate at different speeds, and check the packet loss interval in the driving trajectory.

The test of the automatic driving positioning function module includes:

(1) Select a site with excellent GNSS (Global Navigation Satellite System) signals and relatively complete fixed facilities, arrange a fixed navigation trajectory, and test the positioning accuracy and positioning data update frequency of automatic driving.

Turn on the vehicle's automatic driving positioning module, drive along the navigation trajectory at different speeds, record the content and time of the received positioning data, and calculate the data update frequency f at different speeds; then install a high-precision navigation and positioning system on the same vehicle, record the content of the received data in the same way as the reference positioning data, refer to the positioning accuracy test method of the integrated navigation device to calculate the error between the automatic driving positioning data and the reference data, count the error distribution, and calculate the maximum value, minimum value and average value of the error.

(2) Test the positioning accuracy and data processing time of automatic driving in GNSS signal-blocked areas such as tunnels.

Set control points in the tunnel, use high-precision measuring instruments, such as total stations, etc. to measure the precise position coordinates (X0, Y0) of the control points, turn on the vehicle's automatic driving positioning module, drive the vehicle through the tunnel at different speeds, pass the control point, record the position data (X, Y) and time of the control point output by the automatic driving system, calculate the error of (X0, Y0) and (X, Y), analyze the change of error over time, and count the error distribution and the maximum, minimum, and average values of the error.

Add timestamps at the points where the automatic driving positioning module starts to receive sensor data and output positioning data, calculate the time difference ΔPT between input and output data, record the ΔPT value within time Δτ, and count the distribution of ΔPT.

The present disclosure also provides a positioning device for automatic driving, wherein the device comprising: a memory, a processor, and an automatic driving positioning program stored on the memory and running on the processor, the automatic driving positioning program is configured to implement steps of the positioning method for automatic driving.

The present disclosure also provides an electronic storage medium, wherein at least one instruction or at least one section of program is stored in the storage medium, and the at least one instruction or at least one section of program is loaded and executed by a processor to implement the positioning method for automatic driving.

The integrated navigation of the present disclosure adopts GNSS and IMU integrated navigation.

The present disclosure adopts a real-time closed-loop automatic driving positioning system based on the fusion of integrated navigation and laser SLAM, which can make up for the defect that satellite signals are easily affected by the environment, further improve the reliability of integrated navigation, and effectively improve the positioning accuracy. The positioning data input from the integrated navigation device and laser SLAM in the positioning system for automatic driving is processed by the extended Kalman filter, and the output result data will be used to screen the positioning data input from the integrated navigation device and laser SLAM, and reversely verify the validity of the input positioning data. At the same time, using a real-time laser positioning method based on deep learning to output laser positioning data with high accuracy and strong robustness makes the result of fusion positioning more reliable and optimizes the overall performance of the positioning system.

At the same time, it provides a test method for the positioning system for automatic driving, and establishes a set of positioning system for automatic driving suitable for various integrated navigation devices. Different from the system-level testing methods adopted by existing automatic driving systems, the present disclosure starts from two aspects of the test of the integrated navigation device and the test of the positioning function to test positioning system for automatic driving, and conduct a relatively comprehensive test on the positioning system for automatic driving. The test operation is simple and the reliability is high.

The above is only an embodiment of the present invention, and does not limit the patent scope of the present disclosure. Any equivalent structure or equivalent process transformation made by using the description of the present disclosure and the contents of the accompanying drawings, or directly or indirectly used in other related technologies fields, all of which are equally included in the scope of patent protection of the present disclosure.

1. A positioning method for automatic driving, comprising:
inputting data sets of position, velocity and attitude angle, and real-time laser point cloud data;
processing the acquired data sets of position, velocity and attitude angle by using extended Kalman filter method;
processing the acquired real-time laser point cloud data by using a laser SLAM algorithm and then using the extended Kalman filter method;
acquiring fusion output positioning data after the processing with the extended Kalman filter method, and eliminating input abnormal data by using the fusion output positioning data to form closed-loop processing.

2. The positioning method for automatic driving according to claim 1, wherein the real-time laser point cloud data is processed by using the laser SLAM algorithm to generate data of position and heading angle.

3. The positioning method for automatic driving according to claim 1, wherein the positioning method comprising:
generating fusion output positioning data of position, velocity and attitude angle after the processing with the extended Kalman filter method, and using the fusion output positioning data to eliminate abnormal data in input data to form closed-loop processing.

4. The positioning method for automatic driving according to claim 3, wherein using the fusion output positioning data to eliminate abnormal data in input data comprising:
step 1: determining starting points of the fusion positioning output data, an input position trajectory and a laser SLAM position trajectory;
step 2: using linear interpolation method to perform interval resampling on the fusion positioning output data, the input position trajectory and the laser SLAM position trajectory in step 1;
step 3: calculating a distance between resampling points with an equal interval, and extracting and eliminating abnormal position data input from integrated navigation and the laser SLAM;
step 4: based on fusion output velocity data, extracting and eliminating input abnormal velocity data by using curve similarity analysis method;
step 5: based on fusion output attitude angle data, extracting and eliminating abnormal angle data input from the integrated navigation and the laser SLAM by using the curve similarity analysis method.

5. A positioning system for automatic driving, comprising: an integrated navigation device module, a laser radar module, an automatic driving controller module and an automatic driving positioning module,
the integrated navigation device module is configured to provide data sets of position, velocity and attitude angle to the automatic driving positioning module;
the laser radar module is configured to provide real-time laser point cloud data to the automatic driving positioning module;
the automatic driving positioning module is configured to implement a positioning method for automatic driving;
the automatic driving controller module is configured to run the automatic driving positioning module.

6. The positioning system for automatic driving according to claim 5, wherein the automatic driving positioning module adopts an automatic driving positioning program based on integrated navigation and laser SLAM fusion technology to implement closed-loop processing of the positioning system for automatic driving.

7. A test method applicable to the positioning system for automatic driving according to claim 5 or claim 6, the test method comprising:
complete the test of the positioning system for automatic driving by combined test of the integrated navigation device module and the automatic driving positioning module.

8. The testing method according to claim 7, wherein test steps of the integrated navigation device module comprising:
testing positioning stability of the integrated navigation device in a static state;
testing changes of different positioning states of the integrated navigation device in a motion state;
using a high-precision navigation and positioning system as reference to test positioning accuracy of the integrated navigation device;
testing switching time between a fixed solution and a non-fixed solution of the integrated navigation device;
testing change in time of repeated cold starts of the integrated navigation device;
testing and analyzing packet loss rate and packet loss interval of the integrated navigation device;
test steps of the automatic driving positioning module comprising:
in a site with excellent GNSS signals and complete fixed facilities, arranging a fixed navigation trajectory to test positioning accuracy and update frequency of positioning data for automatic driving; and
testing the positioning accuracy and data processing time in a GNSS signal blocked area.

9. (canceled)

10. (canceled)
